(19) United States
(12) Patent Application Publication
(10) Pub. No.: US 2002/0137477 A1
(43) Pub. Date: Sep. 26, 2002

(54) Input system for portable terminal, portable terminal, control unit, and input program for portable terminal

(75) Inventor: Munenori Sawada, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/067,263

(22) Filed: Feb. 7, 2002

(30) Foreign Application Priority Data
Mar. 21, 2001 (JP) 2001-080386

(51) Int. Cl. H04B 1/38

(52) U.S. Cl. 455/90; 455/575; 455/347

(57) ABSTRACT

The present invention provides an input system for a portable terminal which is suitable for easing input operations on multiple applications installed on a portable terminal, without specializing the applications.

A portable terminal on which control units are detachably mounted asks, during application start-up, for one or more of the control units to be selected and when one or more control units are selected, accepts input in the application through the selected control unit(s).

### BACKGROUND OF THE INVENTION

1. Field of the Invention

The present invention relates to a system which accepts input from a plurality of control units as well as to a terminal and program applied to the system. More particularly, it relates to an input system for a portable terminal, portable terminal, control unit, and input program for the portable terminal which are suitable for easing input operations on multiple applications installed on the portable terminal, without specializing the applications.

2. Description of the Related Art

Widely known input devices for portable terminals such as a PDA (personal digital assistant) include a jog dial disclosed by Japanese published unexamined application 11-161402 and push buttons currently in vogue.

Portable terminals equipped with a jog dial allow application users to scroll up and down by turning the dial and carry out a Select or Enter operation by pressing down the dial in the radial direction.

Portable terminals equipped with push buttons allow application users to scroll up and down by using specific buttons and assign some other buttons to frequently used operations, which then can be performed by using the assigned buttons.

### SUMMARY OF THE INVENTION

On the other hand, recent portable terminals, due to the recent diversification of their uses, have been undergoing changes from a form which incorporates a single application to implement fixed functionality to a form which incorporates a number of applications to implement a variety of functionality. Some applications are suitable for jog-dial operations, others are suitable for push-button operations.

However, conventional portable terminals are equipped with a specific input device, be it a jog-dial type or push-button type. Consequently, input operations are troublesome when running applications suitable for push-button operations on portable terminals equipped with a jog-dial or when running applications suitable for jog-dial operations on portable terminals equipped with push-buttons. Unlike desktop personal computers, one of the major reasons why portable terminals employ special input devices is the demand for smaller portable terminals, which presents a problem of how to implement a variety of operations in a small space.

As a method for solving this problem, all the applications to be incorporated into portable terminals with a jog dial may be designed to be suitable for jog-dial operations and all the applications to be incorporated into portable terminals with push buttons maybe designed to be suitable for push-button operations.

However, if an application is designed with an input device in mind, the resulting application may extremely lack versatility, being applicable, in effect, only to portable terminals equipped with the specific input device. For all that, creating an application tailored to each input device will result in increased development costs and is not acceptable.

The present invention has been made in view of these unsolved problems. Its object is to provide an input system for a portable terminal, portable terminal, control unit, and input program for the portable terminal which are suitable for easing input operations on multiple applications installed on the portable terminal, without specializing the applications.

To accomplish the above object, an input system for a portable terminal according to claim 1 of the present invention comprises a portable terminal which uses a control unit for input, wherein the above described control unit is detachably mounted on the above described portable terminal.

By attaching and detaching control units, this configuration allows control units to be replaced, making it possible to use different control units for different applications.

According to claim 2 of the present invention, in the input system for a portable terminal set forth in claim 1, a plurality of control units are detachably mounted on the above described portable terminal, and one or more control units can be selected from the above described plurality of control units and the above described portable terminal uses the selected control unit(s) for input.

This configuration allows one or more control units to be used selectively from among a plurality of control units, making it possible to use different control units for different applications.

Selections from the control units can be made on the portable terminal or a different terminal provided separately. Also, control units may be selected by users or applications or other processes. This also applies to the input system for a portable terminal set forth in claim 3, the portable terminal set forth in claim 13, and the input programs for a portable terminal set forth in claims 15 and 16.

Also, input in the portable terminal only needs to be entered via one or more selected control units. Specifically, if a single control unit is selected, input can be entered only through that control unit, and if two or more control units are selected, input may be entered through individual control units or a combination of control units. This also applies to the input system for a portable terminal set forth in claim 3, the portable terminal set forth in claim 13, and the input programs for a portable terminal set forth in claims 15 and 16.

Also, the present system may be implemented as an independent portable terminal or a network system connecting a portable terminal with other types of terminal and allowing them to communicate with each other. In the latter case, components may belong either to the portable terminal or to the other terminals, provided that they are connected such that they can communicate with each other. This also applies to the input system for a portable terminal set forth in claim 3.

Furthermore, an input system for a portable terminal according to claim 3 of the present invention comprises a portable terminal which accepts input from a plurality of control units, wherein one or more control units can be selected from the above described plurality of control units and the above described portable terminal uses the selected control unit(s) for input.

This configuration allows one or more control units to be used selectively from among a plurality of control units, making it possible to use different control units for different applications.

The portable terminal here needs only to allow a plurality of control units to be selected: the control units may be installed in advance or provided as detachable units. This also applies to the portable terminal set forth in claim 13 and the input programs for a portable terminal set forth in claims 15 and 16.

Furthermore, in the input system for a portable terminal according to claim 4 of the present invention, in the input system for a portable terminal set forth in claim 3, the above described control units are detachably mounted on the above described portable terminal.

By attaching and detaching control units, this configuration allows control units to be replaced, making it possible to use different control units for different applications.

Furthermore, in the input system for a portable terminal according to claim 5 of the present invention, in the input system for a portable terminal set forth in claim 2 or 4, the above described portable terminal comprises contact detection plates for detecting contact on plate surfaces and accepts input from the above described control units based on the result of detection performed by the above described contact detection plates; and each of the above described control units comprises movable contacts which, being mounted on the above described portable terminal in such a way as to lie on one of the above described contact detection plates, come into and out of contact with the above described contact detection plate.

According to this configuration in which the control unit is mounted on the portable terminal in such a way as to lie on the contact detection plate, when the user operates the movable contacts bringing them into contact with the contact detection plate, the portable terminal detects via the contact detection plate that a movable contact is in contact with the contact detection plate and input is entered from the control unit based on the result of the detection. Thus, with this portable terminal, input from the control unit is entered by making and breaking contact between the movable contacts and contact detection plate.

Furthermore, in the input system for a portable terminal according to claim 6 of the present invention, in the input system for a portable terminal set forth in claim 5, each of the above described control units comprises ID contacts which come into contact with unique parts of the above described contact detection plate when the above described control unit is mounted on the above described portable terminal in such away as to lie on the above described contact detection plate; and the above described portable terminal detects the places of contact between the above described contact detection plate and ID contacts and identifies the above described control unit based on the result of the detection.

According to this configuration, when a control unit is mounted on the portable terminal in such a way as to lie on a contact detection plate, bringing the contact detection plate into contact with the ID contacts, the portable terminal detects the places of contact between the contact detection plate and ID contacts and identifies the control unit based on the result of the detection because the places of contact are unique to the control unit.

Furthermore, in the input system for a portable terminal according to claim 7 of the present invention, in the input system for a portable terminal set forth in claim 6, the above described portable terminal comprises storage means for storing control unit information for each of the above described control units, detects the places of contact between the above described contact detection plate and the above described ID contacts, searches the above described storage means for appropriate control unit information based on the result of the detection, and identifies the above described control unit based on the retrieved control unit information.

According to this configuration, the portable terminal detects the places of contact between the contact detection plate and ID contacts and searches the storage means for appropriate control unit information based on the result of the detection. Then it identifies the control unit based on the retrieved control unit information.

The storage means here stores the control unit information using any means at any time: the control unit information may be stored in advance or may be stored via external input or the like during the operation of the system without being stored in advance. This also applies to the input system for a portable terminal set forth in claim 10.

Furthermore, in the input system for a portable terminal according to claim 8 of the present invention, in the input system for a portable terminal set forth in claim 2 or 4, the above described portable terminal comprises portable-terminal-side connection terminals for connecting electrically with the above described control units and accepts input from the above described control units through electrical communications with the above described portable-terminal-side connection terminals; and each of the above described control units comprises a control-unit-side connection terminal for connecting electrically with one of the above described portable-terminal-side connection terminals and operation means to be operated by the user, and in response to the operation of the above described operation means, changes the content of electrical signals associated with electrical communications between the above described control-unit-side connection terminal and the above described portable-terminal-side connection terminal.

According to this configuration, after the control unit is mounted on the portable terminal by connecting the control-unit-side connection terminal and the portable-terminal-side connection terminal and thereby enabling electrical communications between the control unit and portable terminal, when the operation means is operated by the user, changes are made to the content of electrical signals associated with electrical communications between the above described control-unit-side connection terminal and the above described portable-terminal-side connection terminal. Consequently, the portable terminal accepts input from the control unit through the electrical communications with the portable-terminal-side connection terminal. Thus, for this portable terminal, input is provided as changes in the electrical signals associated with electrical communications between the control-unit-side connection terminal and portable-terminal-side connection terminal.

Furthermore, in the input system for a portable terminal according to claim 9 of the present invention, in the input system for a portable terminal set forth in claim 8, each of the above described control units connects its ID circuit to the above described control-unit-side connection terminal to change the content of electrical signals associated with electrical communications between the above described control-unit-side connection terminal and the above described portable-terminal-side connection terminal into unique content; and the above described portable terminal identifies the above described control unit based on the electrical communications between the above described control-unit-side connection terminal and the above described ID circuit.

According to this configuration, when a control unit is mounted on the portable terminal by connecting the control-unit-side connection terminal and portable-terminal-side connection terminal and thereby enabling electrical communications between the control unit and portable terminal, the ID circuit changes the content of electrical signals associated with electrical communications between the control-unit-side connection terminal and the portable-terminal-side connection terminal. The portable terminal can identify the control unit because changes in the content of electrical signals are unique to individual control units.

Furthermore, in the input system for a portable terminal according to claim 10 of the present invention, in the input system for a portable terminal set forth in claim 9, the above described portable terminal comprises storage means for storing control unit information for each of the above described control units, acquires ID information based on electrical communications between the above described portable-terminal-side connection terminal and the above described ID circuit, searches the above described storage means for appropriate control unit information based on the acquired ID information, and identifies the above described control unit based on the retrieved control unit information.

According to this configuration, the portable terminal acquires ID information based on electrical communications between the portable-terminal-side connection terminal and the ID circuit and searches the storage means for appropriate control unit information based on the acquired ID information. Then, it identifies the control unit based on the retrieved control unit information.

Furthermore, in the input system for a portable terminal according to claim 11 of the present invention, in the input system for a portable terminal set forth in any of claims 2 and 4 to 10, the above described portable terminal asks, during application start-up, for one or more of the above described control units to be selected and when one or more control units are selected, accepts input in the application through the selected control unit(s).

According to this configuration, the portable terminal asks the user during application start-up to select one or more of the control units. When the user enters his/her selection of one or more control units, the portable terminal accepts input in the application through the selected control unit(s).

On the other hand, to achieve the above object, a portable terminal according to claim 12 of the present invention is applicable to the input system for a portable terminal set forth in claim 1, and capable of being fitted with the above described control units.

This configuration offers the same effects as the portable terminal in the input system for a portable terminal set forth in claim 1.

Furthermore, a portable terminal according to claim 13 of the present invention is applicable to the input system for a portable terminal set forth in claim 3, and accepts input from the above described selected control unit(s).

This configuration offers the same effects as the portable terminal in the input system for a portable terminal set forth in claim 3.

On the other hand, to achieve the above object, a control unit according to claim 14 of the present invention is applicable to the input system for a portable terminal set forth in claim 1, and capable of being mounted on the above described portable terminal.

This configuration offers the same effects as the control unit in the input system for a portable terminal set forth in claim 1.

On the other hand, to achieve the above object, an input program for a portable terminal set forth in claim 15 of the present invention is executed by the input system for a portable terminal set forth in claim 3 consisting of a computer system, allows one or more of the above described control units to be selected, and makes input to be entered in the above described portable terminal via the selected control unit(s).

This configuration, in which the program is read and executed by the input system for a portable terminal, offers the same effects as the input system for a portable terminal set forth in claim 3.

Furthermore, an input program in the input system for a portable terminal according to claim 16 of the present invention is intended for execution by the portable terminal set forth in claim 13 consisting of a computer, and makes input to be entered in the above described portable terminal via the above described selected control unit(s).

This configuration, in which the program is read and executed by the portable terminal, offers the same effects as the portable terminal set forth in claim 13.

### BRIEF DESCRIPTION OF THE DRAWINGS

FIG. 1 is a diagram showing the external configuration of a portable terminal 100 and control unit 200;

FIG. 2 is a plan view and sectional view showing the configuration of the control unit 200;

FIG. 3 is a block diagram showing the internal configuration of the portable terminal 100;

FIG. 4 is a flowchart showing control unit mount processing;

FIG. 5 is a flowchart showing control unit selection processing;

FIG. 6 is a flowchart showing control unit removal processing;

FIG. 7 is a block diagram showing the configuration of the portable terminal 100 and control unit 200;

FIG. 8 is a block diagram showing the internal configuration of the portable terminal 100; and

FIG. 9 is plan views of control units 200 with different configurations.

### DETAILED DESCRIPTION OF THE PREFERRED EMBODIMENTS

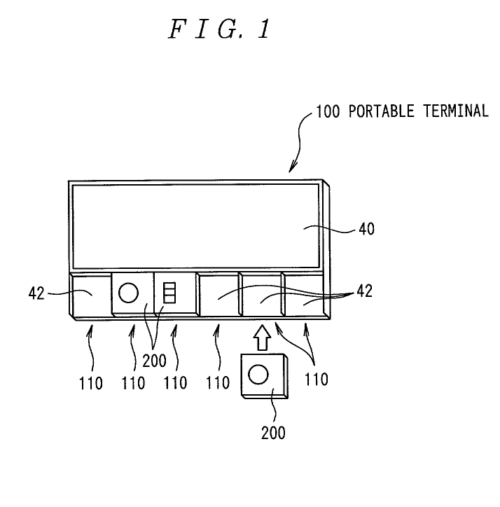

A first embodiment of the present invention will be described below with reference to the drawings. FIGS. 1 to 6 show an input system for a portable terminal, portable terminal, control unit, and input program for a portable terminal according to the first embodiment of the present invention.

This embodiment applies the input system for a portable terminal, portable terminal, control unit, and input program for a portable terminal according to the present invention to a case in which a plurality of control units 200 are detachably mounted on a portable terminal 100, as shown in FIG. 1, allowing the user to select a desired control unit 200 for each application and enter input through the selected control unit 200.

First, the external configuration of the portable terminal 100 and control unit 200 will be described with reference to FIG. 1. FIG. 1 is a diagram showing the external configuration of the portable terminal 100 and control unit 200.

As shown in FIG. 1, the outer part of the portable terminal 100 consists of an LCD (liquid crystal display) 40, which constitutes a display screen, and a plurality of sockets 110, each of which can accept a control unit 200.

Each of the sockets 110 has almost the same shape as the planar shape of the control unit 200. They are arranged in a single horizontal row below the LCD 40. The socket 110 has a workpad 42 which serves as a seat for the control unit 200 and detects contact on the plate surface. The control unit 200 is attached to the socket 110 by being placed on the workpad 42 and secured to it. Typically, a pointing device for notebook computers, for example, can be used as the workpad 42. The contact on the plate surface is detected by detecting the pressure, temperature, or electric potential generated by the contact.

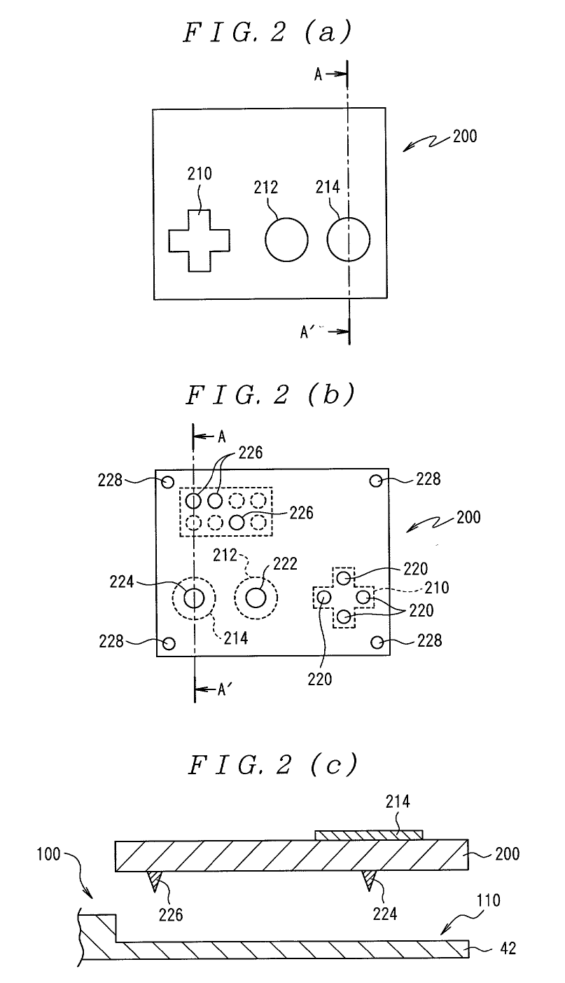

Next, the configuration of the control unit 200 will be described in detail with reference to FIG. 2. FIG. 2(a) is a top view of the control unit 200. FIG. 2(b) is a bottom view of the control unit 200. FIG. 2(c) is a sectional view taken along the line A-A′ of FIGS. 2(a) and 2(b).

As shown in FIGS. 2(a) and 2(c), on the top face of the control unit 200 are a control key 210 for moving objects such as a mouse cursor, and control buttons 212 and 214 for Select, Enter, or Delete operations. The control key 210 is configured as a cross key for pointing four directions: right, left, up, and down.

As shown in FIGS. 2(b) and 2(c), on the bottom face of the control unit 200 are movable contacts 220 which moves in the cross-sectional direction of the control unit 200 along with the operation of the control key 210, movable contacts 222 and 224 which move in the cross-sectional direction of the control unit 200 along with the operation of the control buttons 212 or 214, ID contacts 226 which represent ID information of the control unit 200 according to contact positions, and support members 228 which support the control unit 200 placed on the workpad 42.

The movable contacts 220 are arranged in positions corresponding to the Right, Left, Up, and Down operations of the control key 210. With the control unit 200 fitted in the socket 110, movable contacts 220 are kept out of contact with the workpad 42 by a spring or the like when the control key 210 is not pressed, and they move to come in contact with the workpad 42 when the control key 210 is pressed. Consequently, the portable terminal 100 detects the operation of the control key 210 by detecting the contact between a movable contact 220 and the workpad 42.

The movable contacts 222 and 224 are placed under the control buttons 212 and 214, respectively. With the control unit 200 fitted in the socket 110, movable contacts 222 and 224 are kept out of contact with the workpad 42 by a spring or the like when the control buttons 212 and 214 are not pressed, and they move to come in contact with the workpad 42 when the control buttons 212 and 214 are pressed.

Out of available contact positions arranged at designated intervals in two rows by four columns, the ID contacts 226 are provided such that the contact positions which represent the ID information for identifying the control unit 200 will come in contact with the workpad 42 when the control unit 200 is fitted in the socket 110. Consequently, the portable terminal 100 can obtain the ID information of the control unit 200 by detecting contact between the ID contacts 226 and workpad 42 as well as the places of contact. For example, if the ID contacts 226 are provided such that the first and second contact positions from the left in the upper row and the third contact position from the left in the lower row come in contact with the workpad 42, the ID information of the control unit 200 can be expressed as binary 11000010.

Incidentally, the control unit 200 in FIG. 2 is only exemplary. There are also job-dial type control units 200 and push-button type control units 200.

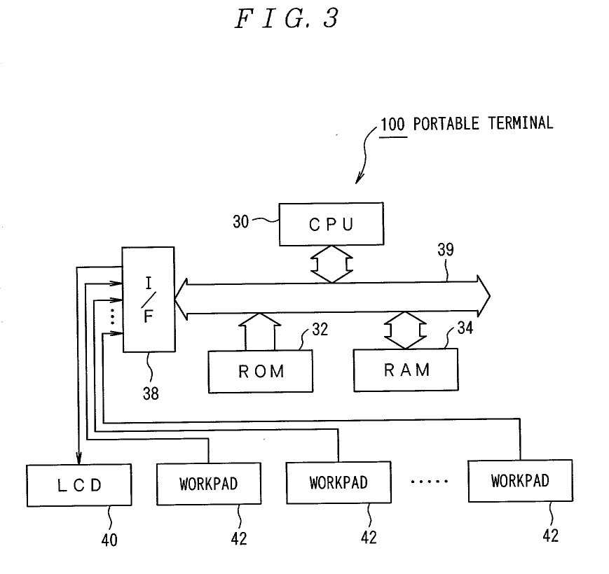

Next, the internal configuration of the portable terminal 100 will be described in detail with reference to FIG. 3. FIG. 3 is a block diagram showing the internal configuration of the portable terminal 100.

As shown in FIG. 3, the portable terminal 100 comprises a CPU 30 which performs operations and controls the entire system based on a control program, ROM 32 for prestoring the control program of the CPU 30 in a designated area, RAM 34 for storing data read out of the ROM 32 and necessary results of CPU 30 operations, and an interface 38 which mediates input and output of data from/to external equipment, all of which are interconnected via a bus 39—which is a signal line for data transfer—to allow data exchange among them.

The interface 38 is connected with an LCD 40 and a plurality of workpads 42 as external equipment.

In the ROM 32, control unit information of control units 200 is stored, being associated with the ID information of the respective control units 200. The control unit information contains registration information of the respective control units 200 and various other information needed to run the control units on applications.

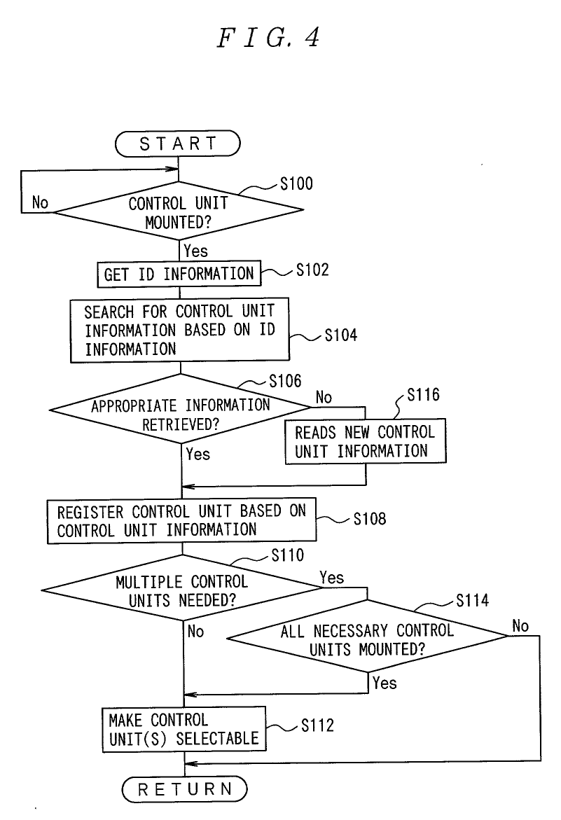

The CPU 30 consists of a microprocessing unit (MPU), etc. It starts a designated program stored in a designated area of the ROM 32 and performs processing shown in the flowcharts of FIGS. 4 to 6—control unit mount processing, control unit selection processing, and control unit removal processing—on a time-shared basis according to the program. The ROM 32 contains a number of applications and the CPU 30 executes applications at the user's request.

First, the control unit mount processing will be described in detail with reference to FIG. 4. FIG. 4 is a flowchart showing the control unit mount processing.

The control unit mount processing involves detecting that a control unit 200 has been mounted in a socket 110 and registering the detected control unit 200. It is performed by the CPU 30 beginning with Step S100 as shown in FIG. 4.

In Step S100, the system judges based on a detection signal from a workpad 42 whether a control unit 200 has been mounted in a socket 110. If it is judged that a control unit 200 has been mounted in a socket 110 (Yes), the system goes to Step S102. Otherwise (No), the system waits in Step S100.

In Step S102, the system obtains the ID information of the control unit 200 based on the detection signal from the workpad 42, goes to Step S104, where it searches the ROM 32 for control unit information based on the obtained ID information, and then goes to Step S106.

In Step S106, the system judges whether appropriate control unit information has been retrieved. If it is judged that appropriate control unit information has been retrieved (Yes), the system goes to Step S108, where it registers the control unit 200 in a database based on the retrieved control unit information, and then goes to Step S110.

In Step S106, the system judges whether the registered control unit 200 is used in combination with other control units 200. If it is judged that the control unit 200 is not used in combination (No), the system goes to Step S112, where it makes the control unit 200 available for selection by applications, finishes the sequence of processes, and returns to the beginning.

On the other hand, if it is judged in Step S110 that the registered control unit 200 is used in combination with other control units 200 (Yes), the system goes to Step S114, where it judges with reference to the database whether all the necessary control units 200 have been mounted. If it is judged that all the necessary control units 200 have been mounted (Yes), the system goes to Step S112. Otherwise (No), the system finishes the sequence of processes and returns to the beginning.

On the other hand, if it is judged in Step S106 that no appropriate control unit information has been retrieved (No), the system goes to Step S116, where it reads new control unit information, and then goes to Step S118. If it turns out in Step S116 that no new control unit information is contained in the ROM 32, the system prompts the user to provide new control unit information and waits for the user to provide new control unit information.

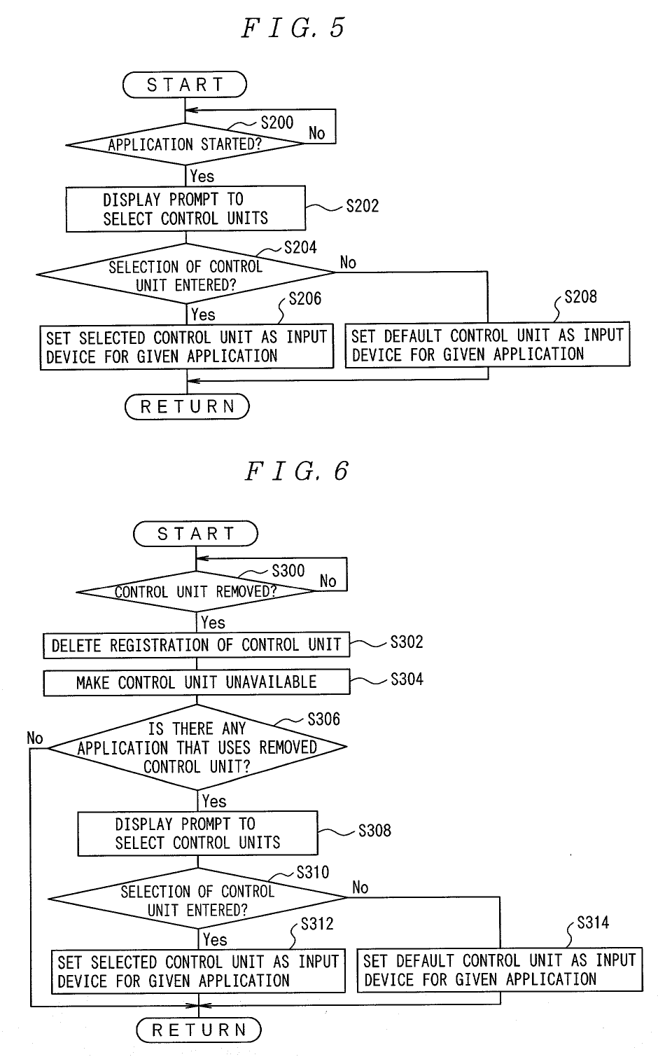

Next, the control unit selection processing will be described in detail with reference to FIG. 5. FIG. 5 is a flowchart showing the control unit selection processing.

The control unit selection processing involves selecting a control unit 200 for use as an input device by the application to be executed. It is performed by the CPU 30 beginning with Step S200 as shown in FIG. 5.

In Step S200, the system judges whether an application has been started. If it is judged that an application has been started (Yes), the system goes to Step S202. Otherwise (No), the system waits in Step S200 for an application to start.

In Step S202, the system displays a prompt on the LCD 40 with reference to the database, asking the user to select one or more control units 200 from out of the available control units 200 mounted in sockets 110. Then it goes to Step S204.

In Step S204, the system judges whether the selection of a control unit 200 has been entered. If it is judged that the selection of a control unit 200 has been entered (Yes), the system goes to Step S206, where it sets the selected control unit 200 as the input device for the application, finishes the sequence of processes, and returns to the beginning.

On the other hand, if it is judged in Step S204 that no selection of a control unit 200 has been entered (No), the system goes to Step S208, where it sets the default control unit 200 as the input device for the application, finishes the sequence of processes, and returns to the beginning.

Next, control unit removal processing will be described in detail with reference to FIG. 6. FIG. 6 is a flowchart showing the control unit removal processing.

The control unit removal processing involves detecting that a control unit 200 has been removed from a socket 110 and deleting the registration of the detected control unit 200. It is performed by the CPU 30 beginning with Step S300 as shown in FIG. 6.

In Step S300, the system judges based on a detection signal from a workpad 42 whether a control unit 200 has been removed from a socket 110. If it is judged that a control unit 200 has been removed from a socket 110 (Yes), the system goes to Step S302. Otherwise (No), the system waits in Step S300.

In Step S302, the system deletes the registration of the removed control unit 200 from the database, goes to Step S304, where it makes the control unit 200 unavailable to applications, and then goes to Step S306.

In Step S306, the system judges whether there is a running application which uses the removed control unit 200. If it is judged that there is a running application which uses the removed control unit 200 (Yes), the system goes to Step S308, where it displays a prompt on the LCD 40 with reference to the database, asking the user to select one or more control units 200 from out of the available control units 200 mounted in sockets 110. Then it goes to Step S310.

In Step S310, the system judges whether the selection of a control unit 200 has been entered. If it is judged that the selection of a control unit 200 has been entered (Yes), the system goes to Step S312, where it sets the selected control unit 200 as the input device for the application, finishes the sequence of processes, and returns to the beginning.

On the other hand, if it is judged in Step S310 that no selection of a control unit 200 has been entered (No), the system goes to Step S314, where it sets the default control unit 200 as the input device for the application, finishes the sequence of processes, and returns to the beginning.

On the other hand, if it is judged in Step S306 that there is no running application which uses the removed control unit 200 (No), the system finishes the sequence of processes, and returns to the beginning.

Now the operation of the first embodiment above will be described.

First, description will be given about a case in which the control unit 200 is mounted on the portable terminal 100.

When a control unit 200 is mounted in a socket 110, the ID contacts 226 comes in contact with the workpad 42, through which the portable terminal 100 detects contact between the ID contacts 226 and workpad 42 as well as the places of contact. Through Steps S100 to S104, the portable terminal 100 obtains the ID information of the control unit 200 based on the detection signal from the workpad 42 and searches the ROM 32 for control unit information based on the obtained ID information. If appropriate control unit information is retrieved, the system registers the control unit 200 in the database through Steps S106 and S108, based on the retrieved control unit information. If the registered control unit 200 is not used in combination with other control units 200, then through Steps S110 and S112, the system makes the control unit 200 available for selection by applications.

Incidentally, if the mounted control unit 200 is used in combination with other control units 200, then through Steps S110, S114, and S112, the system makes the control unit 200 available for selection by applications only after all the necessary control units 200 have been mounted.

Next, description will be given about a case in which a desired control unit 200 is used on an application.

To use a desired control unit 200 on an application, first the user starts the application on the portable terminal 100.

When the application is started, then through Steps S200 and S202, the portable terminal 100 displays a prompt on the LCD 40 asking the user to select one or more control units 200 from out of the available control units 200 mounted in sockets 110. If the user selects one or more desired control units 200, then through Steps S204 and S206, the selected control unit(s) 200 is/are set as the input device(s) for the application.

For example, if the user selects the control unit 200 shown in FIG. 2, when the control key 210 or the control button 212 or 214 is pressed during the execution of the given application, the appropriate one of the movable contacts 220 to 224 comes in contact with the workpad 42 and the portable terminal 100 detects the contact between the movable contact (220,222, or 224) and workpad 42 as well as the place of contact. The result of the detection is recognized as input from the control key 210 or the control button 212 or 214.

Incidentally, if the user does not select a control unit 200 in response to the prompt during application start-up, then through Steps S204 and S208, the default control unit 200 is set as the input device for the application.

Next, description will be given about a case in which a control unit 200 is removed from the portable terminal 100.

When a control unit 200 is removed from a socket 110, then through Steps S302 and S304, the portable terminal 100 deletes the registration of the removed control unit 200 from the database and makes the control unit 200 unavailable to applications.

Incidentally, if there is a running application which uses the removed control unit 200, then through Steps S306 and S308, the system displays a prompt on the LCD 40 asking the user to select one or more control units 200 from out of the available control units 200 mounted in sockets 110. If the user selects one or more desired control units 200, then through Steps S310 and S312, the selected control unit(s) 200 is/are set as the input device(s) for the application.

In this way, according to this embodiment, control units 200 are detachably mounted on the portable terminal 100, allowing one or more of them to be selected for use in input operations.

As a result, on the portable terminal 100 which incorporates two or more applications, input operations on the applications are made relatively easier to perform without specializing the applications.

Furthermore, according to this embodiment, the portable terminal 100 asks, during application start-up, for one or more control units 200 to be selected and when one or more control units 200 are selected, accepts input in the application through the selected control unit(s) 200.

As a result, the user can select suitable control units 200 for each application, further easing input operations on the application.

Furthermore, according to this embodiment, the portable terminal 100 comprises workpads 42 which detect contact on the plate and the input from the control units 200 is entered based on the result of detection performed by the workpads 42; and each of the control unit 200 comprises movable contacts 220 to 224 which, being mounted on the portable terminal 100 in such a way as to lie on one of the workpads 42, come into and out of contact with the workpad 42.

As a result, the control unit 200 only needs to have the movable contacts 220 to 224, which makes it possible to simplify its structure and produce it relatively inexpensively.

Furthermore, according to this embodiment, each control unit 200 comprises ID contacts 226 which come into contact with unique parts of the workpad 42 when the control unit 200 is mounted on the portable terminal 100; and the portable terminal 100 detects the places of contact between the workpad 42 and ID contacts 226 and identifies the control unit 200 based on the result of the detection.

As a result, the control unit 200 only needs to have the ID contacts 226, which makes it possible to identify the control unit 200 using a relatively simple structure.

In the first embodiment described above, the workpad 42 corresponds to the contact detection plate described in claims 5 to 7 while the ROM 32 corresponds to the storage means described in claim 7.

Now a second embodiment of the present invention will be described below with reference to the drawings. FIG. 1 and FIGS. 4 to 8 show an input system for a portable terminal, portable terminal, control unit, and input program for a portable terminal according to the second embodiment of the present invention. Incidentally, only those parts which are different from the first embodiment will be described below. The same parts as those in the first embodiment will be denoted by the same reference numerals and description thereof will be omitted.

This embodiment applies the input system for a portable terminal, portable terminal, control unit, and input program for a portable terminal according to the present invention to a case in which a plurality of control units 200 are detachably mounted on a portable terminal 100, as shown in FIG. 1, allowing the user to select a desired control unit 200 for each application and enter input through the selected control unit 200. It differs from the first embodiment described above in that input from the control unit 200 is received through electrical communications between the control unit 200 and the portable terminal 100.

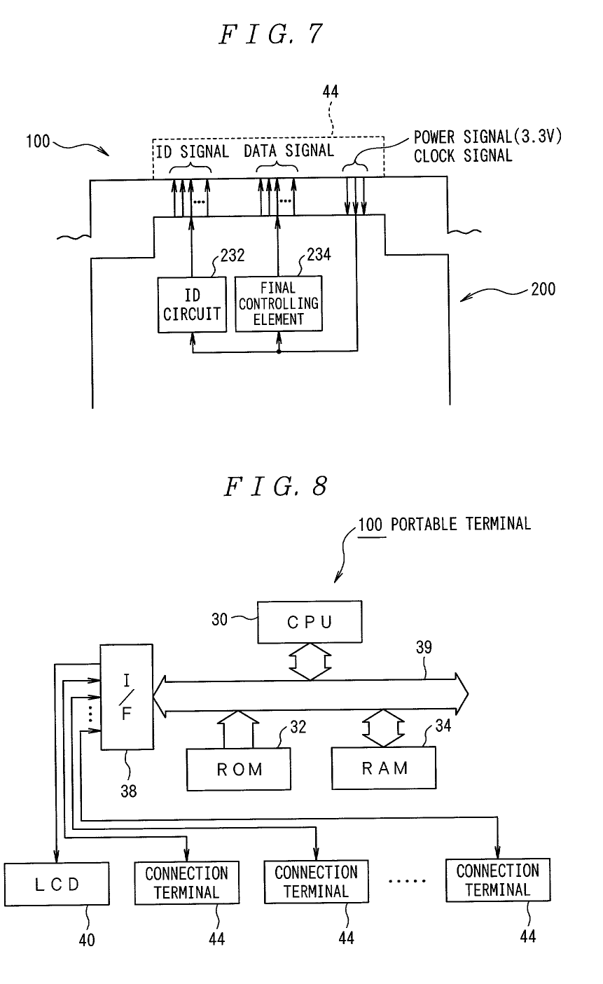

First, the configuration of the portable terminal 100 and control unit 200 will be described with reference to FIG. 7. FIG. 7 is a block diagram showing the configuration of the portable terminal 100 and control unit 200.

The outer part of the portable terminal 100 consists of an LCD 40, which constitutes a display screen, and a plurality of sockets 110, each of which can accept a control unit 200. As shown in FIG. 7, each socket 110 is provided with a connection terminal 44 to connect electrically with control units 200. The connection terminal 44 outputs a power signal and clock signal and receives an ID signal which represents ID information of the control units 200 and a data signal which represents operations of the control units 200.

As shown in FIG. 7, the control unit 200 consists of a connection terminal 230 for connecting electrically with the connection terminal 44, an ID circuit 232 which outputs an ID signal, and a final controlling element 234 to be operated by the user.

The ID circuit 232 receives the power signal and clock signal, modifies the power signal synchronously with the clock signal so that the power signal will represent designated ID information, and outputs the resulting signal as the ID signal. Specifically, it generates the ID signal which represents the ID information, by short-circuiting or opening those power signal lines which represent the ID information of the given control unit 200, out of a certain number of power signal lines. Consequently, the portable terminal 100 can obtain the ID information of the control unit 200 by demodulating the ID signal received from the connection terminal 44. For example, if the first, second, and seventh power signal lines out of eight lines are open, the ID information of the control unit 200 can be expressed as binary 00111101.

The final controlling element 234 receives the power signal and clock signal, modifies the power signal synchronously with the clock signal according to the operation of the final controlling element 234, and outputs the resulting signal as the data signal.

Next, the internal configuration of the portable terminal 100 will be described in detail with reference to FIG. 8. FIG. 8 is a block diagram showing the internal configuration of the portable terminal 100.

As shown in FIG. 8, the portable terminal 100 consists of a CPU 30, ROM 32, RAM 34, and interface 38 connected via a bus. The interface 38 is connected with an LCD 40 and a plurality of connection terminals 44 as external equipment.

The CPU 30 consists of a microprocessing unit (MPU), etc. It starts a designated program stored in a designated area of the ROM 32 and performs processing equivalent to the control unit mount processing, control unit selection processing, and control unit removal processing shown in the flowcharts of FIGS. 4 to 6 on a time-shared basis according to the program.

Next, the operation of the second embodiment above will be described. The following description uses the flowcharts of the control unit mount processing, control unit selection processing, and control unit removal processing shown in FIGS. 4 to 6.

First, description will be given about a case in which the control unit 200 is mounted on the portable terminal 100.

When a control unit 200 is mounted in a socket 110, then through Steps S100 to S104, the portable terminal 100 obtains ID information of the control unit 200 based on an ID signal from the connection terminal 44 and searches the ROM 32 for control unit information based on the obtained ID information. If appropriate control unit information is retrieved, the system registers the control unit 200 in the database through Steps S106 and S108, based on the retrieved control unit information. If the registered control unit 200 is not used in combination with other control units 200, the system makes the control unit 200 available for selection by applications, through Steps S110 and S112.

Incidentally, if the mounted control unit 200 is used in combination with other control units 200, then through Steps S110, S114, and S112, the system makes the control unit 200 available for selection by applications only after all the necessary control units 200 have been mounted.

Next, description will be given about a case in which a desired control unit 200 is used on an application.

To use a desired control unit 200 on an application, first the user starts the application on the portable terminal 100.

When the application is started, then through Steps S200 and S202, the portable terminal 100 displays a prompt on the LCD 40 asking the user to select one or more control units 200 from out of the available control units 200 mounted in sockets 110. If the user selects one or more desired control units 200, then through Steps S204 and S206, the selected control unit(s) 200 is/are set as the input device(s) for the application. Consequently, during the execution of the application, input from the control unit 200 is received through electrical communications between the connection terminal 44 and connection terminal 230.

Incidentally, if the user does not select a control unit 200 in response to the prompt during application start-up, then through Steps S204 and S208, the default control unit 200 is set as the input device for the application.

Next, description will be given about a case in which a control unit 200 is removed from the portable terminal 100.

When a control unit 200 is removed from a socket 110, then through Steps S302 and S304, the portable terminal 100 deletes the registration of the removed control unit 200 from the database and makes the control unit 200 unavailable to applications.

Incidentally, if there is a running application which uses the removed control unit 200, then through Steps S306 and S308, the system displays a prompt on the LCD 40 asking the user to select one or more control units 200 from out of the available control units 200 mounted in sockets 110. If the user selects one or more desired control units 200, then through Steps S310 and S312, the selected control unit(s) 200 is/are set as the input device(s) for the application.

In this way, according to this embodiment, control units 200 are detachably mounted on the portable terminal 100, allowing one or more of them to be selected for use in input operations.

As a result, on the portable terminal 100 which incorporates two or more applications, input operations on the applications are made relatively easier to perform without specializing the applications.

Furthermore, according to this embodiment, the portable terminal 100 asks, during application start-up, for one or more control units 200 to be selected and when one or more control units 200 are selected, accepts input in the application through the selected control unit(s) 200.

As a result, the user can select suitable control units 200 for each application, further easing input operations on the application.

Furthermore, according to this embodiment, the portable terminal 100 comprises the connection terminals 44 for connecting electrically with control units 200 and accepts input from the control units 200 through electrical communications with the connection terminals 44; and each of the control units 200 comprises the connection terminal 230 for connecting electrically with one of the connection terminals 44 and a final controlling element 234 to be operated by the user, and in response to the operation of the final controlling element 234, changes the content of electrical signals associated with electrical communications between the connection terminal 230 and the connection terminal 44.

As a result, the control unit 200 only needs to have a circuit and the like for changing the content of electrical signals associated with electrical communications between the connection terminal 230 and the connection terminal 44, which makes it possible to simplify its structure and produce it relatively inexpensively.

Furthermore, according to this embodiment, each control unit 200 connects its ID circuit 232 to the connection terminal 230 to change the content of electrical signals associated with electrical communications between the connection terminal 230 and connection terminal 44 into unique content; and the portable terminal 100 identifies the control unit 200 based on the electrical communications between the connection terminal 44 and the ID circuit 232.

As a result, the control unit 200 only needs to have the ID circuit 232, which makes it possible to identify the control unit 200 using a relatively simple structure.

In the second embodiment described above, the connection terminal 44 corresponds to the portable-terminal-side connection terminal described in claims 8 to 10, the connection terminal 230 corresponds to the control-unit-side connection terminal according to claim 8 or 9, the final controlling element 234 corresponds to the operation means described in claim 8, and the ROM 32 corresponds to the storage means described in claim 10.

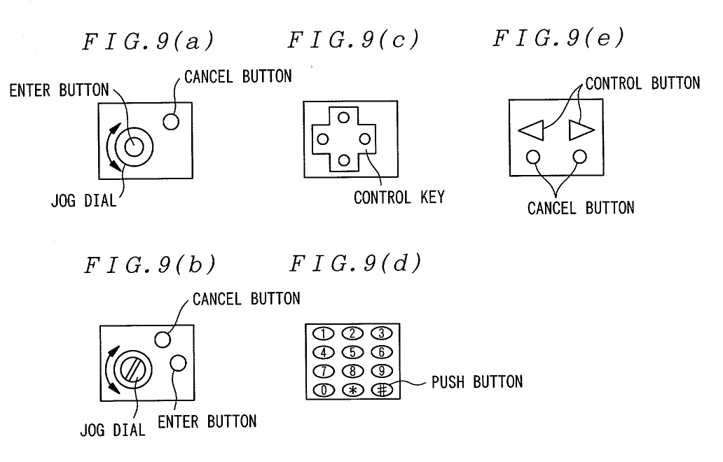

Incidentally, although the control unit 200 according to the first embodiment described above has the control key 210 and the control buttons 212 and 214 as shown in FIG. 2, this is not restrictive, and it is also possible to adopt a control unit 200 with a configuration such as the one shown in FIG. 9. FIG. 9 shows plan views of control units 200 with different configurations.

The control unit 200 shown in FIG. 9A is configured with an Enter button, a Cancel button, and a jog dial which is installed coaxially with the Enter button and can rotate freely around it. This configuration is suitable for database applications such as address management applications. The control unit 200 shown in FIG. 9B differs from the one shown in FIG. 9 A in that the Enter button and the jog dial are installed at different locations.

The control unit 200 shown in FIG. 9C is configured with a cross key for pointing four directions: right, left, up, and down. It is suitable for game applications. The control unit 200 shown in FIG. 9D, which is configured with multiple push buttons, is suitable for data input applications such as word processing applications.

The control unit 200 shown in FIG. 9E is configured with a control key capable of pointing two directions—right and left—and two Cancel buttons. It is suitable for game applications as in the case with the control unit 200 shown in FIG. 9C.

Also, the first and second embodiments described above use a plurality of control units 200 for input. Specifically, for example, a plurality of control units 200 may be combined to function as a single control unit 200. There is a limit to the number of keys or buttons which the control unit 200 according to the present invention can carry because of the limited size of the socket 110. Therefore, it is difficult, for example, to include all the keys of a keyboard in a single control unit 200. However, it is possible to use a combination of two or three control units 200 as a keyboard by distributing keys to them and making them to be recognized as a single control unit 200. In that case, the ID information of a single control unit 200 does not make sense. The control units 200 are enabled only when the ID information of all the control units 200 is provided. The database which manages the registration of mounted control units manages the combination of the multiple control units 200 as a single control unit.

The use of a combination of multiple control units 200 as a keyboard makes it possible not only to compensate for the disadvantage that each control unit 200 can carry a limited number of keys and buttons, but also to configure a keyboard which will suit the user's taste by changing the combination. Suppose, for example, four control units 200—a main-input-key control unit 200 consisting of alphanumeric keys and the like, an auxiliary-input-key control unit 200 consisting of a shift key and the like, a numeric key control unit 200, and a function key control unit 200—are combined to provide a completed keyboard with complete functionality, then the user who wants only main input keys and numeric keys needs to combine only the appropriate two control units 200 while the user who wants only a numeric keyboard needs to use only the appropriate one of the four control units 200. In this case, there is no need to have all ID information before enabling the control units 200. Functionality can be expanded stepwise each time ID information is added.

Although in the first and second embodiments described above, the processing shown in the flowcharts of FIGS. 4 to 6 is performed by the execution of the program stored in the ROM 32 in advance, this is not restrictive, and it is also possible to run programs of the above procedures by reading them to the RAM 34 from a recording medium.

The recording medium here may be any recording medium, provided it is computer-readable, regardless of what reading method it uses: electronic, magnetic, or optical. It may be a semiconductor recording medium such as RAM or ROM; magnetic recording medium such as an FD or HD; optical recording medium such as a CD, CDV, LD, or DVD; or magneto-optical recording medium such as an MO.

Also, although in the first and second embodiments described above, the input system for a portable terminal, portable terminal, control unit, and input program for a portable terminal according to the present invention are applied to a case in which a plurality of control units 200 are detachably mounted on the portable terminal 100, allowing the user to select a desired control unit 200 for each application and enter input through the selected control unit 200, they can be applied to other cases without departing from the spirit and scope of the present invention.

As described above, according to the input system for a portable terminal set forth in claims 1, 2, and 5 to 11 of the present invention, on the portable terminal 100 which incorporates two or more applications, input operations on the applications are made relatively easier to perform without specializing the applications.

Furthermore, according to the input system for a portable terminal set forth in claims 3 to 11 of the present invention, on the portable terminal which incorporates two or more applications, input operations on the applications are made easier to perform without specializing the applications.

Furthermore, according to the input system for a portable terminal set forth in claims 5 to 7 of the present invention, the control unit only needs to have movable contacts, which makes it possible to simplify its structure and produce it relatively inexpensively.

Furthermore, according to the input system for a portable terminal set forth in claim 6 or 7 of the present invention, the control unit only needs to have ID contacts, which makes it possible to identify the control unit using a relatively simple structure.

Furthermore, according to the input system for a portable terminal set forth in claims 8 to 10 of the present invention, the control unit only needs to have a circuit and the like for changing the content of electrical signals associated with electrical communications between the control-unit-side connection terminal and portable-terminal-side connection terminal, which makes it possible to simplify its structure and produce it relatively inexpensively.

Furthermore, according to the input system for a portable terminal set forth in claim 9 or 10 of the present invention, the control unit only needs to have an ID circuit, which makes it possible to identify the control unit using a relatively simple structure.

Furthermore, according to the input system for a portable terminal set forth in claim 11, the user can select suitable control units for each application, further easing input operations on the application.

Besides, the portable terminal set forth in claim 12 provides benefits almost equivalent to those provided by the input system for a portable terminal set forth in claim 1.

Furthermore, the portable terminal set forth in claim 13 provides benefits almost equivalent to those provided by the input system for a portable terminal set forth in claim 3.

Besides, the control unit set forth in claim 14 provides benefits almost equivalent to those provided by the input system for a portable terminal set forth in claim 1.

Besides, the input program for a portable terminal set forth in claim 15 provides benefits almost equivalent to those provided by the input system for a portable terminal set forth in claim 3.

Furthermore, the input program for a portable terminal set forth in claim 16 provides benefits almost equivalent to those provided by the portable terminal set forth in claim 13.

What is claimed is:

1. An input system for a portable terminal, comprising a portable terminal which uses a control unit for input, wherein:
said control unit is detachably mounted on said portable terminal.

2. The input system for a portable terminal according to claim 1, wherein:
a plurality of control units are detachably mounted on said portable terminal; and
one or more control units can be selected from said plurality of control units and said portable terminal uses the selected control unit(s) for input.

3. An input system for a portable terminal, comprising a portable terminal which uses a plurality of control unit for input, wherein:
one or more control units can be selected from said plurality of control units and said portable terminal uses the selected control unit(s) for input.

4. The input system for a portable terminal according to claim 3, wherein:
said control units are detachably mounted on said portable terminal.

5. The input system for a portable terminal according to claim 2 or 4, wherein:
said portable terminal comprises contact detection plates for detecting contact on plate surfaces and accepts input from said control units based on the result of detection performed by said contact detection plates; and
each of said control units comprises movable contacts which, when said control unit is mounted on said portable terminal in such away as to lie on one of said contact detection plates, come into and out of contact with said contact detection plate by move.

6. The input system for a portable terminal according to claim 5, wherein:
each of said control units comprises ID contacts which come into contact with unique parts of said contact detection plate when said control unit is mounted on said portable terminal in such a way as to lie on said contact detection plate; and
said portable terminal detects the places of contact between said contact detection plate and ID contacts and identifies said control unit based on the result of the detection.

7. The input system for a portable terminal according to claim 6, wherein:
said portable terminal comprises storage means for storing control unit information for each of said control units, detects the places of contact between said contact detection plate and said ID contacts, searches said storage means for appropriate control unit information based on the result of the detection, and identifies said control unit based on the retrieved control unit information.

8. The input system for a portable terminal according to claim 2 or 4, wherein:
said portable terminal comprises portable-terminal-side connection terminals for connecting electrically with said control units and accepts input from said control units through electrical communications with said portable-terminal-side connection terminals; and
each of said control units comprises a control-unit-side connection terminal for connecting electrically with one of said portable-terminal-side connection terminals and operation means to be operated by the user, and in response to the operation of said operation means, changes the content of electrical signals associated with electrical communications between said control-unit-side connection terminal and said portable-terminal-side connection terminal.

9. The input system for a portable terminal according to claim 8, wherein:
each of said control units connects ID circuit to said control-unit-side connection terminal, said ID circuit changes the content of electrical signals associated with electrical communications between said control-unit-side connection terminal and said portable-terminal-side connection terminal into unique content; and
said portable terminal identifies said control unit based on the electrical communications between said portable-terminal-side connection terminal and said ID circuit.

10. The input system for a portable terminal according to claim 9, wherein:
said portable terminal comprises storage means for storing control unit information for each of said control units, acquires ID information based on electrical communications between said portable-terminal-side connection terminal and said ID circuit, searches said storage means for appropriate control unit information based on the acquired ID information, and identifies said control unit based on the retrieved control unit information.

11. The input system for a portable terminal according to any of claims 2 and 4 to 10, wherein:
said portable terminal requires, during application start-up, for one or more of said control units to be selected and when one or more control units are selected, accepts input for the application from the selected control unit(s).

12. A portable terminal applicable to the input system for a portable terminal according to claim 1, wherein:
said portable terminal can be fitted with said control units.

13. A portable terminal applicable to the input system for a portable terminal according to claim 3, wherein:
said portable terminal uses the selected conctrol unit for input.

14. A control unit applicable to the input system for a
portable terminal according to claim 1, wherein
said control unit can be mounted on said portable terminal.

15. An input program to be executed by the input system for
a portable terminal according to claim 3 consisting of
a computer system, wherein
said program is program which is executed operation, said operation can be selected one or more control units from said plurality of control units and makes input to be accepted in said portable terminal via the selected control unit.

16. An input program to be executed by the portable terminal
according to claim 13 consisting of a computer system, wherein said program is program which is executed operation, said operation makes input to be accepted in said portable terminal via the selected control unit.
